(19) United States
(12) Patent Application Publication
(10) Pub. No.: US 2014/0359116 A1
(43) Pub. Date: Dec. 4, 2014

(54) ELECTRONIC DEVICE AND DATA TRACKING METHOD

(71) Applicant: HON HAI PRECISION INDUSTRY CO., LTD., New Taipei (TW)

(72) Inventors: LI-KANG HUNG, New Taipei (TW); JEN-HUNG LO, New Taipei (TW); TING-LING CHANG CHIEN, New Taipei (TW); CHEN-HSIEN CHEN, New Taipei (TW); MENG-LUNG SHEN, New Taipei (TW)

(73) Assignee: HON HAI PRECISION INDUSTRY CO., LTD., New Taipei (TW)

(21) Appl. No.: 14/291,179

(22) Filed: May 30, 2014

(30) Foreign Application Priority Data
May 31, 2013 (TW) 102119518

(51) Int. Cl. H04L 12/26

(52) U.S. Cl. CPC H04L 43/06
USPC 709/224

(57) ABSTRACT

An electronic device records operation log of an application when the application is operated by an account on the electronic device. The electronic device uploads the operation log of the application to a server connected to the electronic device. The electronic device displays the operation log of the application in a screen of the electronic device.

### FIELD

Embodiments of the present disclosure relate to data tracking technology, and particularly to an electronic device and a data tracking method.

### BACKGROUND

It is convenient for a student to study online with the development of education applications (e.g., a dictionary application) using an electronic device (e.g., a mobile phone or a tablet computer). For example, the student can use the dictionary application to study vocabulary on the electronic device. However, the student may also spend time playing games when the student uses the electronic device, instead of studying. It is desirable to supervise behaviors of the student when the student uses the electronic device, accordingly a supervisor (e.g., a teacher) can help the student to study.

### BRIEF DESCRIPTION OF THE DRAWINGS

Implementations of the present technology will now be described, by way of example only, with reference to the attached figures, wherein:

FIG. 1 is a block diagram of one embodiment of an electronic device connected to a server.

FIG. 2 is a block diagram of one embodiment of a data tracking system in the electronic device in FIG. 1.

FIG. 3 is a flowchart illustrating one embodiment of a data tracking method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure

Several definitions that apply throughout this disclosure will now be presented.

The term “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

The present disclosure is described in relation to data tracking technology.

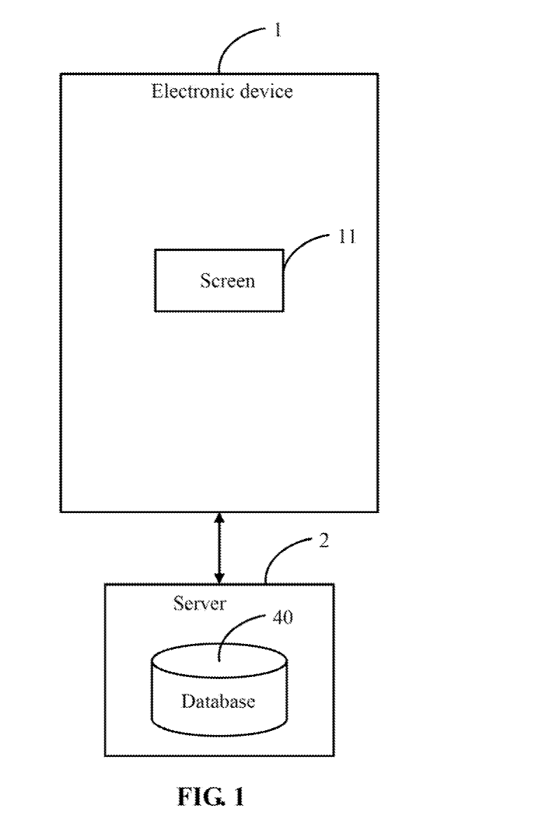

FIG. 1 illustrates a block diagram of one embodiment of an electronic device 1 connected to a server 2. Depending on the embodiment, the electronic device 1 is wirelessly connected to the server 2 via a network (e.g., the Internet or a local area network), as shown in FIG. 1. The electronic device 1 may be, but is not limited to, a personal computer (PC), a tablet computer, a smart mobile phone, a thin electronic device or any other devices.

The electronic device 1 tracks an operation log of an application when an authorized user operates the application on the electronic device 1. The application can be, but is not limited to, a browser, a game application, an education application, or any other applications that are installed in the electronic device 1. The operation log includes operation behavior of the application and operation time of the application. For example, if the application is the browser, the electronic device 1 records the operation log, such as, web pages that have been accessed, the amount of the time that each page has been viewed, and the searches that have been conducted on the browser, when the authorized user operates a browser on the electronic device 1. If the application is the education application, the electronic device 1 records the pages of the application that have been viewed, the amount of time that each page has been viewed, the searches that have been conducted on the application, and test scores that have been made. The electronic device 1 includes a screen 11. The screen 11 displays the operation log. The server 2 includes a database 40. The database 40 can be in a memory of the server 2, or in a storage device that connected to the server 2. For example, the server 2 can be connected to the database 40 using a data connectivity, such as open database connectivity (ODBC) or JAVA database connectivity (JDBC). The server 2 stores the operation log uploaded from the electronic device 1 into the database 2.

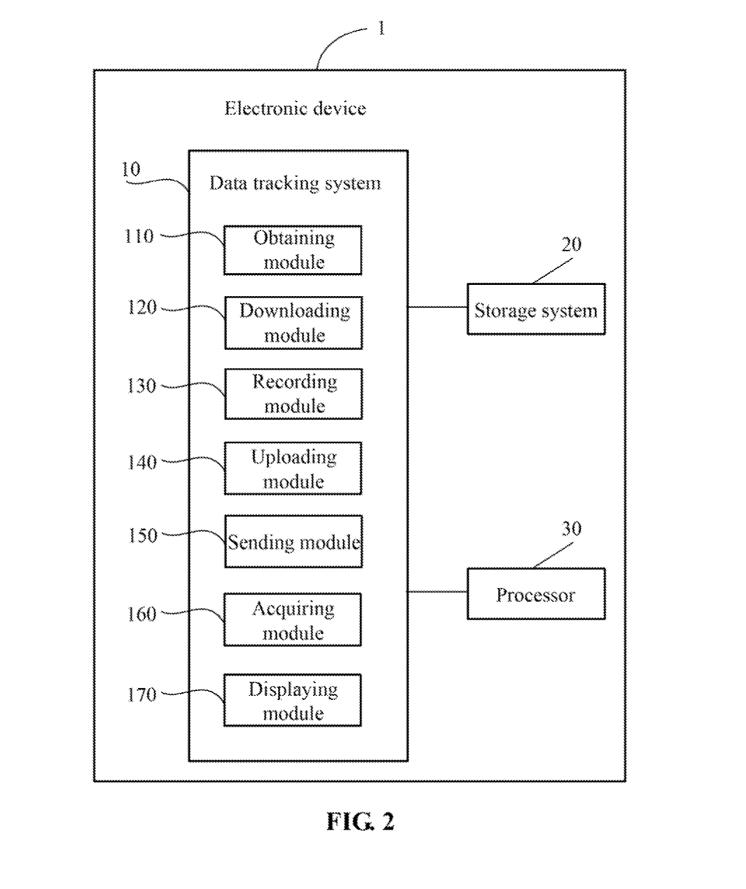

FIG. 2 illustrates a block diagram of one embodiment of a data tracking system in the electronic device. In one embodiment, the data tracking system 10 includes an obtaining module 110, a downloading module 120, a recording module 130, an uploading module 140, a sending module 150, an acquiring module 160, and a displaying module 170. The modules 110-170 may include computerized code in the form of one or more programs that are stored in a storage system 20 of the electronic device 1. The computerized code includes instructions that are executed by the at least one processor 30 of the electronic device 20 to provide functions for modules 110-170. The storage system 20 can be a memory chip, a hard disk drive, or a flash memory stick.

The obtaining module 110 obtains information of an account when the account logs on to the electronic device 1. In one embodiment, the information of the account includes a user name and a password. If the account is authorized to the student, and the user name can be a name of the student. The account can be used to log on to one or more applications. The student which is authorized to use the account operates the corresponding applications when the account logs on to the electronic device 1. For example, if the account corresponds to the education application, the student which is authorized to use the account can operate the corresponding education application when the account logs on to the electronic device 1.

The downloading module 120 downloads the application corresponding to the account. In one embodiment, the application is downloaded from the server 2 or any other remote servers, such as a data center. In addition, if the application corresponding to the account is already installed in the electronic device 1, the downloading module 120 does not download the application from the server 2 or any other remote servers.

The recording module 130 records the operation log of the application when the application is executed in the electronic device using the account.

The uploading module 140 uploads the operation log of the application to the server 2, and the server saves the operation log into the database 40. In one embodiment, the uploading module 140 first checks whether the network between the electronic device 1 and the server 2 is normal. The uploading module 140 directly uploads the operation log to the server 2 when the network is normal. The uploading module 140 temporarily saves the operation log into the storage system 20 if the network works abnormally, and uploads the operation log from the storage system 20 to the server 2 when the network works normally. Additionally, the operation log of the application is converted into a report. The report can be a table, a graph, a pie chart, or a bar chart. The report is saved into the database 40 in a data format, such as a JAVASCRIPT object notation (JSON) format.

The sending module 150 sends a check request to the server 2 for checking the operation log of the application. In one embodiment, the sending module 150 generates the check request when an administrator account logs on to the electronic device 1. The administrator account is authorized to guardian people, a teacher or other authorized persons. The authorized person can supervise behaviors of students by checking the operation log. The check request includes a check time, and a user name of the account authorized to the student.

The acquiring module 160 acquires the operation log of the application from the server 2 according to the check request. The acquiring module 160 acquires the operation log from the server 2 using a web service.

The displaying module 170 displays the operation log of the application in the screen 11 of the electronic device 1.

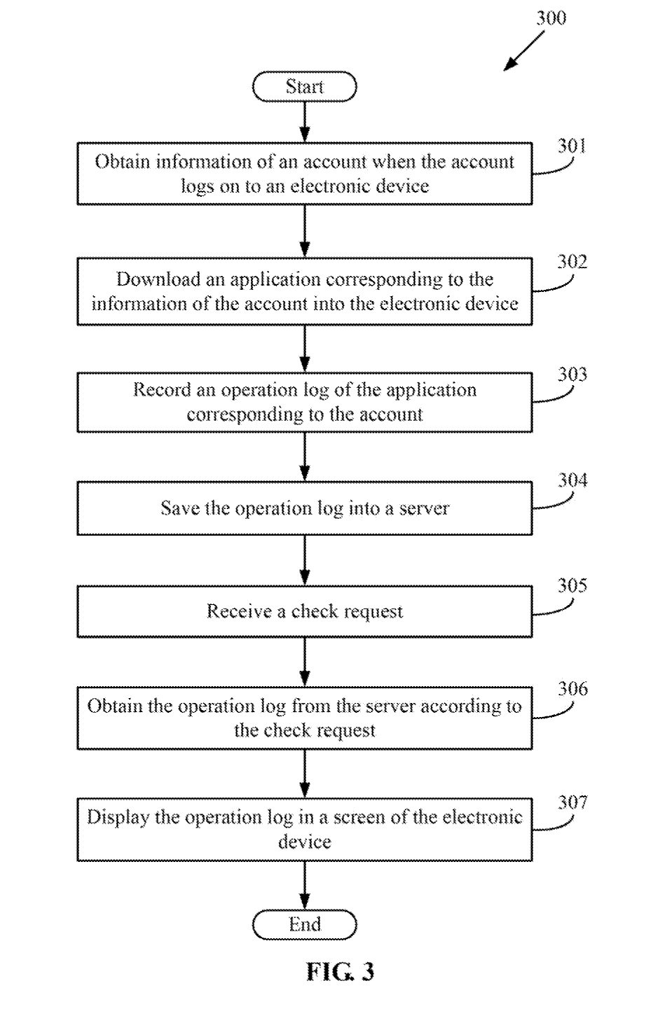

FIG. 3 is a flowchart illustrating one embodiment of a data tracking method. Depending on the embodiment, additional steps may be added, others deleted, and the ordering of the steps may be changed.

Referring to FIG. 3, a flowchart is presented in accordance with an example embodiment which is being thus illustrated. The example method 300 is provided by way of example, as there are a variety of ways to carry out the method. The method 300 described below can be carried out using the configurations illustrated in FIGS. 1 and 2, for example, and various elements of these figures are referenced in explaining example method 300. Each block shown in FIG. 3 represents one or more processes, methods or subroutines, carried out in the exemplary method 300. Additionally, the illustrated order of blocks is by example only and the order of the blocks can change according to the present disclosure. The exemplary method 300 can begin at block 301.

At block 301, the obtaining module obtains information of an account when the account logs on to the electronic device. The account corresponds to one or more applications. If the account corresponds to the education application, the account is authorized to a student for user. The student can operate the education application for study English, for example, when the account logs on to the electronic device.

At block 302, the downloading module downloads the application corresponding to the account from the server or the data center. In one embodiment, the downloading module searches the application using the account in the server or the data center.

At block 303, the recording module records an operation log of the application when the application is executed in the electronic device using the account.

At block 304, the uploading module uploads the operation log of the application to the server, and the server saves the operation log into the database. The operation log of the application is converted into a report. The report can be, a table, a graph, a pie chart, or a bar chart.

At block 305, the sending module sends a check request to the server for checking the operation log of the application. In one embodiment, the sending module 150 generates the check request when an administrator account logs on to the electronic device 1. The administrator is authorized to a teacher. The teacher can supervise the students by checking the operation log. The check request includes a check time, and a user name of the account authorized to the student.

At block 306, the acquiring module receives the operation log of the application from the server. The acquiring module receives the operation log from the server using a web service.

At block 307, the displaying module displays the operation log of the application in the screen of the electronic device.

The embodiments shown and described above are only examples. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A electronic device in communication with a server, the electronic device comprising:
at least one processor; and
a storage system that stores one or more programs, which when executed by the at least one processor, cause the at least one processor to:
obtain information of an account when the account logs on to the electronic device;
download an application corresponding to the information of the account from the server;
record an operation log of the application when the application is executed in the electronic device using the account;
upload the operation log of the application to the server;
send a check request to the server for checking the operation log of the application;
acquire the operation log of the application from the server according to the check request; and
display the operation log of the application in a screen of the electronic device.

2. The electronic device of claim 1, wherein the operation log comprises operation behavior of the application, and operation time of the application.

3. The electronic device of claim 1, wherein the operation log is temporarily saved into the storage system when the network works abnormally, and is uploaded from the storage system to the server when the network works normally.

4. The electronic device of claim 1, wherein the operation log is converted into a format selected from a group consisting of a table, a graph, a pie chart, and a bar chart.

5. The electronic device of claim 1, wherein the operation log is acquired from the server using a web service.

6. The electronic device of claim 1, wherein the check request comprises a check time, and a user name of the account.

7. A data tracking method between an electronic device and a server, the data tracking method comprising:
obtaining information of an account when the account logs on to the electronic device;
downloading an application corresponding to the information of the account from the server;
recording operation log of the application when the application is executed in the electronic device using the account;
uploading the operation log of the application to the server;
sending a check request to the server for checking the operation log of the application;
acquiring the operation log of the application from the server according to the check request; and
displaying the operation log of the application in a screen of the electronic device.

8. The data tracking method of claim 7, wherein the operation log comprises operation behavior of the application, and operation time of the application.

9. The data tracking method of claim 7, wherein the operation log is temporarily saved into a storage system of the electronic device when the network works abnormally, and is uploaded from the storage system to the server when the network works normally.

10. The data tracking method of claim 7, wherein the operation log is converted into a format selected from a group consisting of a table, a graph, a pie chart, and a bar chart.

11. The data tracking method of claim 7, wherein the operation log is acquired from the server using a web service.

12. The data tracking method of claim 7, wherein the check request comprises a check time, and a user name of the account.

13. A non-transitory computer-readable medium having stored thereon instructions that, when executed by an electronic device in communication with a server, causing the electronic device to perform a data tracking method, the method comprising:
obtaining information of an account when the account logs on to the electronic device;
downloading an application corresponding to the information of the account from the server;
recording operation log of the application when the application is executed in the electronic device using the account;
uploading the operation log of the application to the server;
sending a check request to the server for checking the operation log of the application;
acquiring the operation log of the application from the server according to the check request; and
displaying the operation log of the application in a screen of the electronic device.

14. The non-transitory computer-readable medium of claim 13, wherein the operation log comprises operation behavior of the application, and operation time of the application.

15. The non-transitory computer-readable medium of claim 13, wherein the operation log is temporarily saved into a storage system of the electronic device when the network works abnormally, and is uploaded from the storage system to the server when the network works normally.

16. The non-transitory computer-readable medium of claim 13, wherein the operation log is converted into a format selected from a group consisting of a table, a graph, a pie chart, and a bar chart.

17. The non-transitory computer-readable medium of claim 13, wherein the operation log is acquired from the server using a web service.

18. The non-transitory computer-readable medium of claim 13, wherein the check request comprises a check time, and a user name of the account.
